(19) United States
(12) Patent Application Publication
(10) Pub. No.: US 2025/0042457 A1
(43) Pub. Date: Feb. 6, 2025

(54) Utility Cart

(71) Applicant: Abdeslam Anaimi, Woerden (NL)

(72) Inventor: Abdeslam Anaimi, Woerden (NL)

(21) Appl. No.: 18/927,365

(22) Filed: Oct. 25, 2024

Related U.S. Application Data
(63) Continuation of application No. PCT/NL2023/050219, filed on Apr. 24, 2023.

(30) Foreign Application Priority Data
Apr. 25, 2022 (NL) 2031696

(51) Int. Cl. B62B 3/00; B60Q 1/24; B62B 5/00

(52) U.S. Cl. CPC B62B 3/005; B60Q 1/247; B62B 5/00

(57) ABSTRACT

A utility cart including a base, a plurality of storage trays and at least two vertical shafts. Each tray of the plurality of storage trays is attached to at least one of the at least two vertical shafts via at least one fastener. At least one horizontal rail is mounted on the base. The at least two vertical shafts are movably mounted on the at least one horizontal rail via rail-wheels so as to increase or decrease horizontal spacing between at least some trays of the plurality of trays. The at least two vertical shafts are telescopically extensible so as to increase vertical spacing between at least some trays of the plurality of trays.

### CROSS-REFERENCE TO RELATED APPLICATIONS

This application is a continuation of International Patent Application No. PCT/NL2023/050219, filed Apr. 24, 2023, entitled “Utility Cart”, which claims priority to and the benefit of Netherlands Patent Application No. 2031696, entitled “Utility Cart”, filed Apr. 25, 2022, and the specifications and claims thereof are incorporated herein by reference.

### BACKGROUND OF THE INVENTION

### Field of the Invention

The invention relates to a utility cart, and more particularly, a storage cart for storing and displaying articles.

### Background

Utility carts are conventionally known for their use as a transportable cabinet comprising a plurality of drawers and trays, for example, as a tools storage system, library shelves, jewelry shelves or medical shelves. A user of conventional utility carts does not have comfortable access to all the trays or drawers of the utility cart at once. In the case of a utility cart tool storage system, the user loses time looking for the right tool in the right drawer. Furthermore, when using a conventional tool storage system, a user is required to spend additional time and attention for returning a tool back into the right drawer. Most users skip this step which leads to tools being pile-up on top of the utility cart at the end of the day.

### BRIEF SUMMARY OF THE INVENTION

It is an object of the current invention to correct the shortcomings of the prior art and to provide the user with a utility cart wherein all trays/drawers can be comfortably accessed at once. This and other objects which will become apparent from the following disclosure, are provided with a utility cart having the features of one or more of the appended claims.

According to a first aspect of the invention, the utility cart comprises a base, a plurality of storage trays and at least two vertical shafts wherein each tray of the plurality of storage trays is attached to at least one of the at least two vertical shafts via at least one fastener, wherein the utility cart comprises at least one horizontal rail mounted on the base, wherein the at least two vertical shafts are movably mounted on the at least one horizontal rail via rail-wheels so as to increase or decrease horizontal spacing between at least some trays of the plurality of trays, and wherein the at least two vertical shafts are telescopically extensible so as to increase vertical spacing between at least some trays of the plurality of trays. These features allow the user to move the trays sideways and upwards in order to facilitate access to said trays and to improve the visibility of articles stored inside said trays.

In addition, the trays are stackable in at least one column on top of the base wherein said plurality of trays are alternatingly attached to either one of the at least two vertical shafts. Being alternatively attachable basically means that when a tray is attachable to the first shaft, a first following tray is attachable to the second shaft, a second following tray is attachable to the first shaft again and the third following tray is attachable to the second shaft again, and so on, and so forth.

In order to improve the stability of the utility cart, the width of the base is larger than the total width of the stacked plurality of trays.

Advantageously, the at least two vertical shafts comprise vertical struts arranged for providing a tensile pull or push force for bringing the at least two vertical shafts from a contracted position into an extended position and vis-versa. Such vertical struts provide support for upwards movement of the trays even when they are fully loaded. For improved safety and ease of use, said vertical struts are arranged for providing a dampening force for controlling the speed of extension and/or contraction of the at least two vertical shafts.

For further improving the structural rigidity of the utility cart, said utility cart comprises at least one horizontal shaft wherein the at least two vertical shafts are attachable on said at least one horizontal shaft, and wherein said horizontal shaft is telescopically extensible.

The base and/or the at least one horizontal shaft comprise horizontal struts attached to the at least two vertical shafts for moving said at least two vertical shafts on the at least one rail and/or for supporting the telescopic movement of the at least one horizontal shaft by providing a tensile pull or push force on the at least two vertical shafts. Such horizontal struts provide support for horizontal movement of the trays even when they are fully loaded. For improved safety and ease of use, said horizontal struts are arranged for providing a dampening force for controlling the speed of motion of the at least two vertical shafts on the at least one rail of the base.

Accessing the inside of a tray can be further improved by slanting and/or by moving said tray toward the user. Therefore, the utility cart comprises at least one perpendicular rail attached at a distal end of said perpendicular rail to the at least one fastener of at least one storage tray, wherein said at least one storage tray is movably mountable on said at least one perpendicular rail via rail-wheels. Additionally, the perpendicular rail is attachable to the at least one fastener of the at least one storage tray via a rotatable joint for slanting the at least one storage tray.

Suitably, the struts are at least one of gas struts, hydraulic struts, mechanical struts, spring-loaded struts, and electrically controlled struts.

The base comprises wheels, such as swivel caster wheels, for facilitating the movement of the utility cart, wherein said wheels comprise locking means, such as swivel locks and caster pads, for immobilizing the utility cart.

For improving the user friendliness of the utility cart according to the invention, said utility cart comprises at least one electrical socket connectable to an electrical source. The utility cart comprises an air reel fluidly connectable to a source of pressurized air or to an air vacuum. The utility cart comprises a light source mountable on the base and/or on the at least one horizontal shaft for illuminating an area surrounding the utility cart. The utility cart comprises a plurality of light sources mountable on the plurality of storage trays for illuminating said storage trays.

Reference to a first “aspect” or “second” aspect etc. is not intended to suggest a particular hierarchy of the various embodiments described herein. The objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is an illustration showing a front view of an embodiment of the present invention;

FIG. 2 is an illustration showing a back view of an embodiment of the present invention;

FIG. 3 is an illustration showing a front view of an embodiment of the present invention;

FIG. 4 is an illustration showing a front view of an embodiment of the present invention; and

FIG. 5 is an illustration showing a side view of an embodiment of the present invention.

### DETAILED DESCRIPTION OF THE INVENTION

Whenever in the figures the same reference numerals are applied, these numerals refer to the same parts.

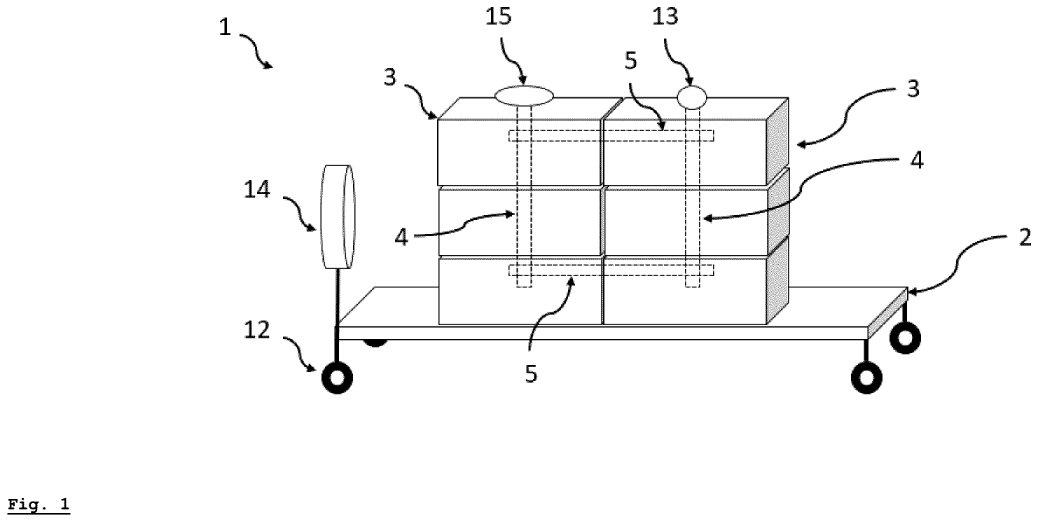

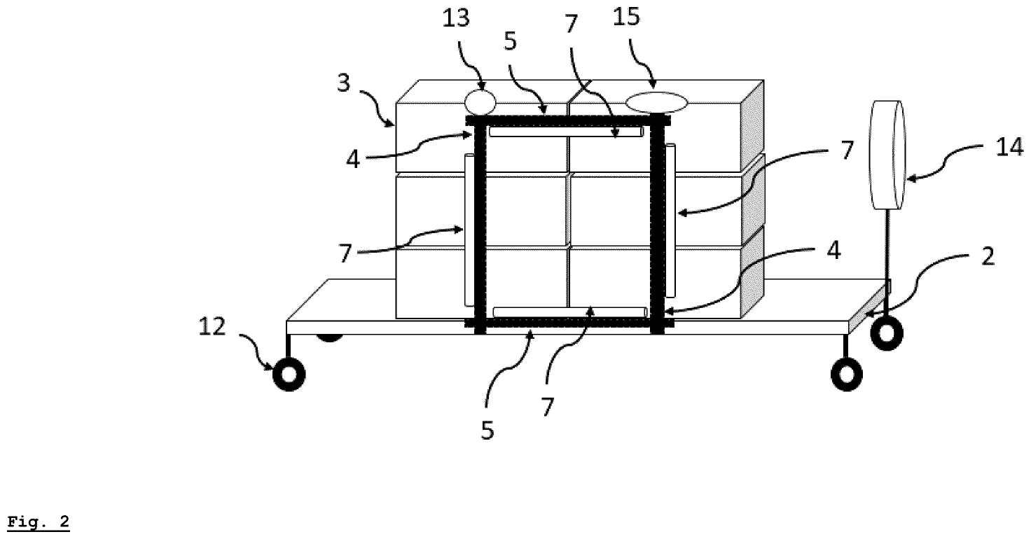

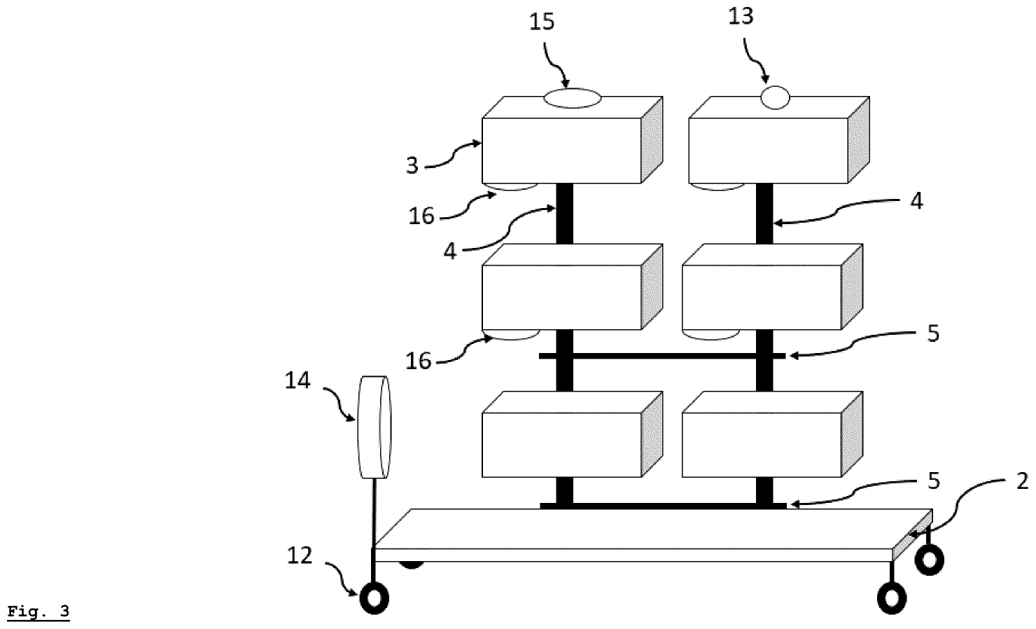

FIGS. 1 and 2 show the utility cart 1 according to the invention in a folded position. A user can bring the utility cart 1 into an unfolded position by moving the trays 3 upwards and sideways. The horizontal struts 7, better seen in FIG. 2, support the sideways movement of the trays 3 by supporting the telescopic extension of the horizontal shaft and by pushing the two vertical shafts sideways, while the vertical struts 7 support the upwards movement of the trays 3 by supporting the telescopic extension of the two vertical shafts. Once unfolded, as seen in FIG. 3, the utility cart 1 stands stable on the floor due to the base 2 having a width larger than the total width of the trays 3. The user can bring back the utility cart 1 to a folded position by pushing the trays 3 downwards and towards the center of the base 2. The horizontal and the vertical struts dampen the speed of motion of the trays so that the user may gently bring back the utility cart into a folded position.

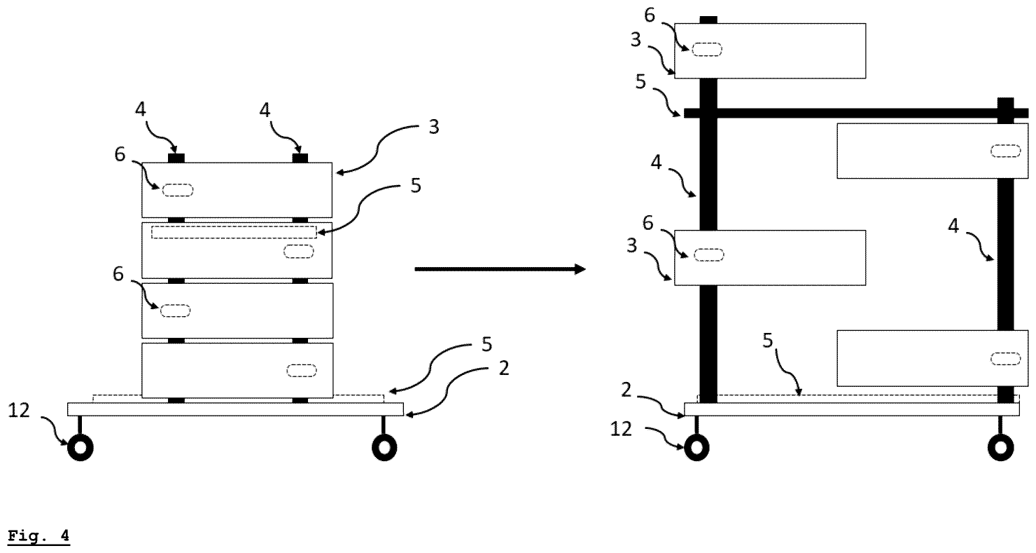

In a second embodiment of the invention, the trays of utility cart 1 may be arranged in one column as shown in FIG. 4. The trays 3 are then alternatively attached to the two vertical shafts 4. When said vertical shafts 4 move sideways, a comfortable access space is created between the trays 3 such that no need for the two vertical shafts 4 to extend. If more space is still needed between the trays 3, the vertical shafts 4 can still be extended.

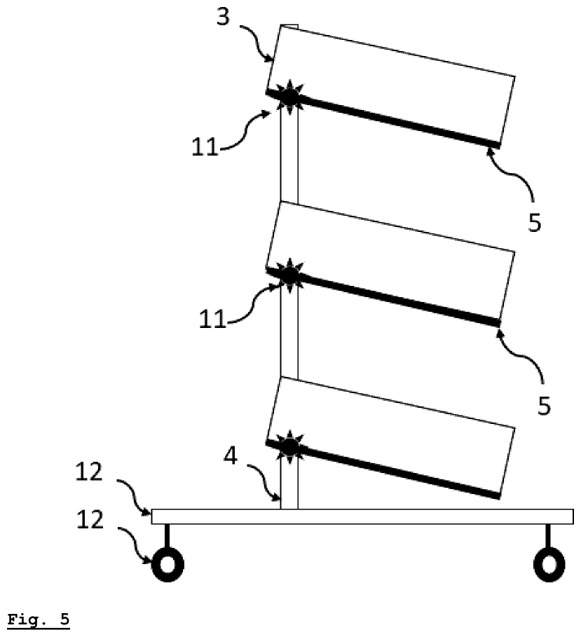

As seen in FIG. 5, slanting the trays 3 downwards and moving them forwards towards the user further eases the accessibility of said trays, and improves the visibility of the stored articles inside said trays 3. For that purpose, the trays 3 are movably mounted on perpendicular rails 5 for allowing forward and backward movement of the trays 3, and said perpendicular rails 3 are attached to the vertical shafts via rotatable joints for allowing downwards and upwards slanting of the trays 3.

A light source 15 may be installed on the utility cart 1 to illuminate a surrounding area. Smaller light sources 16 can be installed on the bottom of upper trays to illuminate lower trays.

An air reel 14 may be installed on the utility cart 1 in order to provide vacuum suction and/or air pressure for the user.

An electrical socket 13 may be installed on the utility cart in order to provide high and/or low voltage electrical power to the user.

For ease of transportation, the utility cart 1 may be equipped with wheels 12 such as lockable caster wheels.

The utility cart 1 of the current invention may be at least one of a tools storage system, library shelves, jewelry shelves and medical shelves.

Although the invention has been discussed in the foregoing with reference to an exemplary embodiment of the method of the invention, the invention is not restricted to this particular embodiment which can be varied in many ways without departing from the invention. The discussed exemplary embodiment shall therefore not be used to construe the append-ed claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another. The terms, “a”, “an”, “the”, and “said” mean “one or more” unless context explicitly dictates otherwise.

What is claimed is:

1. A utility cart comprising:
a base;
a plurality of storage trays; and
at least two vertical shafts,
wherein each tray of the plurality of storage trays is attached to at least one of the at least two vertical shafts via at least one fastener,
wherein the utility cart comprises at least one horizontal rail mounted on the base,
wherein the at least two vertical shafts are movably mounted on the at least one horizontal rail via rail-wheels so as to increase or decrease horizontal spacing between at least some trays of the plurality of trays, and
wherein the at least two vertical shafts are telescopically extensible so as to increase vertical spacing between at least some trays of the plurality of trays.

2. The utility cart according to claim 1 wherein the plurality of trays are stackable in at least one column on top of the base, and wherein said plurality of trays are alternatingly attached to either one of the at least two vertical shafts.

3. The utility cart according to claim 1 wherein the width of the base is larger than the total width of the stacked plurality of trays.

4. The utility cart according to claim 1 wherein the at least two vertical shafts comprise vertical struts arranged for providing a tensile pull or push force for bringing the at least two vertical shafts from a contracted position into an extended position and vis-versa.

5. The utility cart according to claim 4 wherein said vertical struts are arranged for providing a dampening force for controlling the speed of extension and/or contraction of the at least two vertical shafts.

6. The utility cart according to claim 1 further comprising at least one horizontal shaft, wherein the at least two vertical shafts are attached to said at least one horizontal shaft, and wherein said horizontal shaft is telescopically extensible.

7. The utility cart according to claim 1 wherein the base and/or the at least one horizontal shaft comprise horizontal struts attached to the at least two vertical shafts for moving said at least two vertical shafts on the at least one rail of the base and for supporting the telescopic movement of the at least one horizontal shaft by providing a tensile pull or push force on the at least two vertical shafts.

8. The utility cart according to claim 7 wherein said horizontal struts are arranged for providing a dampening force for controlling the speed of motion of the at least two vertical shafts on the at least one rail.

9. The utility cart according to claim 1 further comprising at least one perpendicular rail attached at a distal end to the at least one fastener of at least one storage tray, wherein said at least one storage tray is movably mounted on said at least one perpendicular rail via rail-wheels.

10. The utility cart according to claim 9 wherein the perpendicular rail is attached to the at least one fastener of the at least one storage tray via a rotatable joint for slanting the at least one storage tray.

11. The utility cart according to claim 1 wherein the struts are at least one of gas struts, hydraulic struts, mechanical struts, spring-loaded struts, and electrically controlled struts.

12. The utility cart according to claim 1 wherein the base comprises wheels for facilitating the movement of the utility cart, wherein said wheels comprise locking means for immobilizing the utility cart.

13. The utility cart according to claim 1 further comprising at least one electrical socket connectable to an electrical source.

14. The utility cart according to claim 1 further comprising at least one air reel fluidly connectable to a source of pressurized air or to an air vacuum.

15. The utility cart according to claim 1 further comprising:
a light source mountable on the base and/or on a top storage tray for illuminating an area surrounding the utility cart; and
a plurality of light sources mountable on the plurality of storage trays for illuminating said storage trays.
